(19) United States
(12) Patent Application Publication
(10) Pub. No.: US 2011/0139028 A1
(43) Pub. Date: Jun. 16, 2011

(54) PRINTING APPARATUS AND PRINTING METHOD

(75) Inventor: Yoshimasa Araki, Yokohama-shi (JP)

(73) Assignee: CANON KABUSHIKI KAISHA, Tokyo (JP)

(21) Appl. No.: 12/949,365

(22) Filed: Nov. 18, 2010

(30) Foreign Application Priority Data
Dec. 10, 2009 (JP) 2009-280995

(51) Int. Cl. B41N 3/00

(52) U.S. Cl. 101/465

(57) ABSTRACT

A printing apparatus includes a plate forming member that forms a rewritable plate, a latent image forming unit, a projection forming unit configured to selectively adhere particles to a portion of a surface of the plate forming member where a latent image is formed in order to form a projection, a recording material supply unit, an intermediate transfer member for transfer of a recording material, a pressing unit configured to press the recording material on a surface of the intermediate transfer member during transfer of the recording material to a recording medium, and a conveying unit configured to convey the medium. A surface of the particles has properties to repel the recording material, and the surface of the plate forming member has properties not to repel the recording material. The printing apparatus further includes a unit configured to apply a voltage to the recording material supply unit.

### BACKGROUND OF THE INVENTION

1. Field of the Invention

The present invention relates to an apparatus and a method for on-demand offset printing.

2. Description of the Related Art

Various types of so-called electrophotographic printers such as laser beam printers and LED (light emitting diode) printers have been proposed in the related art, and are widely used for the purpose of on-demand printing. Meanwhile, planographic offset printing has been used since a long time ago for the purpose of producing a large number (for example, 1000 or more) of printed materials of the same content by using a plate.

While modern electrophotographic printers provide a drastically improved image quality, they may not provide sufficient color uniformity (cause significant color differences) in printed materials, the entire surface of which is colored in a single color, or may curl printed materials. In addition, electrophotographic printers do not support printing on thin paper such as newsprint.

Meanwhile, the planographic offset printing has become the main method for newspaper printing, and has enabled to print in color on both surfaces of thin paper at a high speed. A major feature of the planographic offset printing is that the thickness of ink on printed materials is as thin as about 2 μm, which enables to provide printed materials with the feel and texture of the paper left intact.

However, the planographic offset printing requires much time and cost for plate making, and therefore incurs a high cost in the case where the number of prints to be output is small. Thus, the planographic offset printing is not widely used for purposes other than printing a large number of prints.

In view of the above, there has been desired a new printing apparatus that is as convenient as electrophotographic printers but achieves an image quality comparable to the planographic offset printing on demand, and that does not take much time and cost even for a small number of prints to be output.

Japanese Patent Laid-Open No. 10-250027, for example, proposes an offset printing method. In the method, titanium oxide which is hydrophobic is formed on a surface of a latent image formation drum, and irradiated with ultraviolet light in accordance with original electronic data to form a hydrophilic portion. Then, after “dampening water” is supplied to be retained in the hydrophilic portion, ink is adhered to a hydrophobic portion. The method enables on-demand printing by heating the hydrophilic portion mentioned above to a predetermined temperature to restore its original hydrophobic properties.

In contrast, Japanese Patent Laid-Open No. 11-291603 proposes an on-demand relief printing method that does not use “dampening water”. First, an image is formed on an ink-repellent surface of a plate cylinder using toner having an affinity for ink by an electrophotographic printing method, and heated for temporary fixation. Thereafter, ultraviolet-curable non-water offset printing ink is applied onto the toner, and the ink image is irradiated with ultraviolet light for curing to form a temporary “plate” that is firmer than the toner image alone. Non-water planographic printing ink is applied to the plate again, and transferred to a material to be printed (such as paper). After such manipulations for ink supply and transfer are repeated a predetermined number of times, the toner image temporarily fixed on the material with the ink-repellent surface is removed together with the ink image remaining on the toner image to enable on-demand printing.

In the method disclosed in Japanese Patent Laid-Open No. 10-250027, however, dampening water and ink are respectively supplied to the hydrophilic portion and the hydrophobic portion formed on a stepless surface in contrast to a plate for offset printing having steps. Therefore, the edges (contours of characters and images) of the ink which is liquid are only contained by the dampening water which is liquid. Consequently, the edges of the ink may be displaced easily when the ink is transferred to a blanket cylinder. As a result, the contours of characters and images may be deformed from what has been intended, which makes it difficult to keep a high printing quality.

In the method disclosed in Japanese Patent Laid-Open No. 11-291603, meanwhile, ink for printing is applied onto a projection formed by the temporarily fixed toner image (layer) and a layer obtained by curing the ink applied on the toner image with ultraviolet light, and is transferred to paper or the like. Therefore, the ink to be transferred to the paper is placed on the projection with no containment from around the ink, and consequently the edges of the ink may be displaced easily when the ink is transferred to the paper. As a result, the contours of characters and images may be deformed from what has been intended, which makes it difficult to keep a high printing quality.

In addition, the developing process includes three processes, namely (1) a temporal fixation process which uses toner, (2) an ink application process in which ink to be cured as a base is applied, and (3) an ink application process in which ink to be finally transferred to paper is applied. This results in low printing efficiency, which leaves room for improvement in terms of printing speed.

### SUMMARY OF THE INVENTION

The present invention provides a printing apparatus including: a plate forming member that forms a rewritable plate; a latent image forming unit configured to write a latent image onto a surface of the plate forming member; a projection forming unit configured to selectively adhere ink repellent particles to a portion of the surface of the plate forming member where the latent image is formed in order to form a projection; a recording material supply unit configured to supply a recording material to the surface of the plate forming member; an intermediate transfer member for transfer of the recording material supplied to the surface of the plate forming member; a pressing unit configured to press the recording material on a surface of the intermediate transfer member during transfer of the recording material to a recording medium; and a conveying unit configured to convey the recording medium, a surface of the ink repellent particles having properties to repel the recording material, and the surface of the plate forming member having properties not to repel the recording material, and the printing apparatus further including a unit configured to apply a voltage to the recording material supply unit in order to provide the ink repellent particles with adhesion to the plate forming member.

The present invention also provides a printing method including: a first step of writing a latent image onto a surface of a plate forming member that forms a rewritable plate; a second step of adhering ink repellent particles to the surface of the plate forming member on the basis of the latent image to form a projection; a third step of supplying a recording material to the surface of the plate forming member to form an image portion; a fourth step of transferring the recording material on the surface of the plate forming member to an intermediate transfer member; and a fifth step of transferring the recording material on a surface of the intermediate transfer member to a recording medium, a surface of the ink repellent particles having properties to repel the recording material, and the surface of the plate forming member having properties not to repel the recording material, and the printing method further including a step of applying a voltage to a unit configured to supply the recording material in order to provide the ink repellent particles with adhesion to the plate forming member during the third step.

According to the present invention, the ink repellent particles forming the projection on the surface of the plate forming member repel the recording material such as ink. Therefore, a non-image region to which no recording material is to be adhered can be formed reliably. In addition, the surface of the plate forming member has properties not to repel the recording material. Therefore, an image region to which the recording material is to be adhered can be formed reliably on the surface of the plate forming member other than the projection formed by the ink repellent particles.

According to the present invention, a force in the direction from the recording material supply unit such as an ink roller to the plate forming member can be applied to the ink repellent particles when the recording material such as ink is supplied from the recording material supply unit such as an ink roller to the plate forming member. Therefore, the ink repellent particles can be prevented from adhering to the recording material supply unit such as an ink roller and peeling off from the plate forming member. This allows the edges of the ink in the image region to be reliably contained by the ink repellent particles which are solid, which enables to provide a printing apparatus and a printing method that can print with high-quality edges (contours of characters and images) of the recording material.

According to the present invention, in addition, the use of the ink repellent particles eliminates the need for dampening water, which enables to provide an environmentally-friendly printing method.

Further features of the present invention will become apparent from the following description of exemplary embodiments with reference to the attached drawings.

### BRIEF DESCRIPTION OF THE DRAWINGS

FIG. 1 illustrates the configuration of an embodiment of the present invention.

FIG. 2A illustrates an ink transfer process according to the embodiment of the present invention.

FIG. 2B illustrates the ink transfer process according to the embodiment of the present invention.

FIG. 2C illustrates the ink transfer process according to the embodiment of the present invention.

FIG. 2D illustrates an ink transfer process according to the embodiment of the present invention.

FIG. 2E illustrates an ink transfer process according to the embodiment of the present invention.

FIG. 2F illustrates the ink transfer process according to the embodiment of the present invention.

FIG. 3 illustrates a printing process according to the embodiment of the present invention.

### DESCRIPTION OF THE EMBODIMENTS

An embodiment of the present invention will be described below with reference to the drawings.

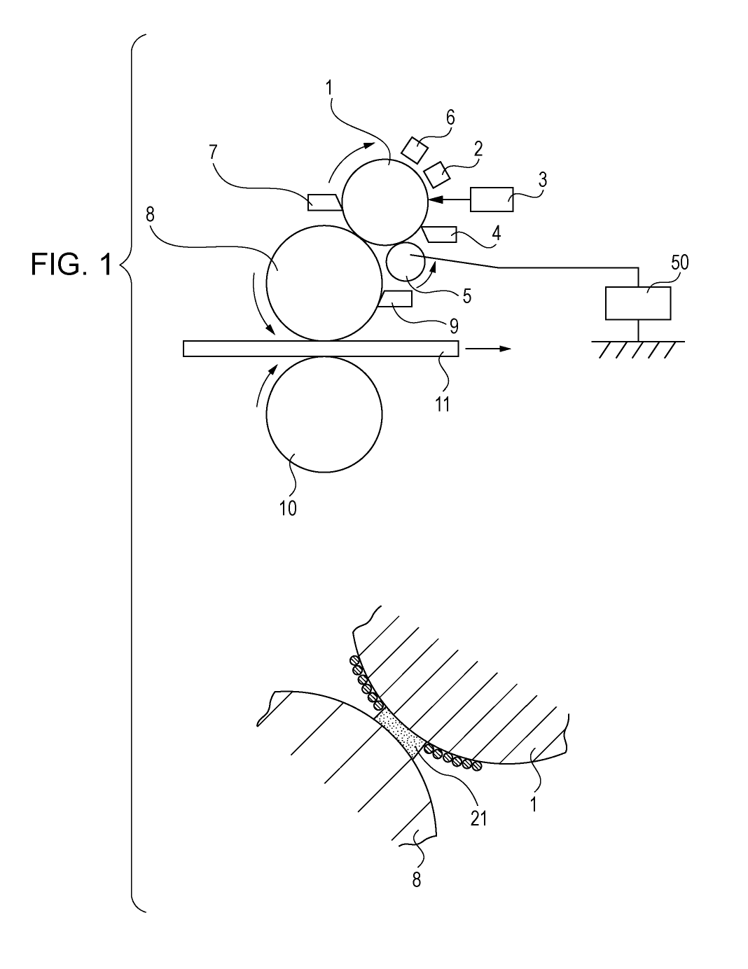

An embodiment of the present invention will be described with reference to FIGS. 1, 2A to 2F, and 3. As shown in FIG. 1, a printing apparatus according to the embodiment includes a photosensitive drum 1 serving as a plate forming member that forms a rewritable plate and made of an amorphous silicon photosensitive member (a-Si). A charger 2, an exposure unit 3, a developing unit 4, an ink roller 5, a charge eliminating unit 6, and a first cleaner 7 are disposed around the photosensitive drum 1. The exposure unit 3 is formed as a latent image forming unit that writes a latent image onto a surface of the photosensitive drum 1 serving as a plate forming member. The developing unit 4 is formed as a projection forming unit that selectively adheres ink repellent particles 20 to a portion of the surface of the photosensitive drum 1 serving as a plate forming member where the latent image is formed in order to form a projection. The ink roller 5 is formed as a recording material supply unit that supplies ink 21 serving as a recording material to the surface of the photosensitive drum 1 serving as a plate forming member. The printing apparatus further includes a blanket cylinder 8 serving as an intermediate transfer member for transfer of the ink 21 serving as a recording material supplied to the surface of the photosensitive drum 1 serving as a plate forming member. Further, a second cleaner 9 and an impression cylinder 10 are disposed around the blanket cylinder 8. The impression cylinder 10 serves as a pressing unit that presses the ink 21 serving as a recording material on a surface of the blanket cylinder 8 during transfer of the ink 21 to paper 11 serving as a recording medium. The blanket cylinder 8 and the impression cylinder 10 also serve as a conveying unit that conveys the paper 11 serving as a recording medium.

The photosensitive drum 1, the ink roller 5, the blanket cylinder 8, and the impression cylinder 10 are driven by a motor (not shown) to rotate in the direction of the respective arrows in FIG. 1 in correspondence with a digital signal sent from a host computer (not shown). In correspondence with this operation, the paper 11 serving as a recording medium is conveyed between the blanket cylinder 8 and the impression cylinder 10 by a conveying unit (not shown).

In the embodiment, commercially available oil-based ink (sheet-fed offset printing ink Diatone Ecopure SOY-HPJ manufactured by SAKATA INX KABUSHIKI KAISHA) is used. As the photosensitive drum 1, an amorphous silicon photosensitive drum that can stably operate with ink containing a solvent is used. A surface (surface protective layer) of the amorphous silicon photosensitive drum 1 is formed by an amorphous material containing at least one of silicon and carbon as a base material, and has an affinity for ink (affinity for oil).

The surface protective layer can be formed by a high-frequency plasma CVD (Chemical Vapor Deposition) method or a PCVD (Plasma Chemical Vapor Deposition) method.

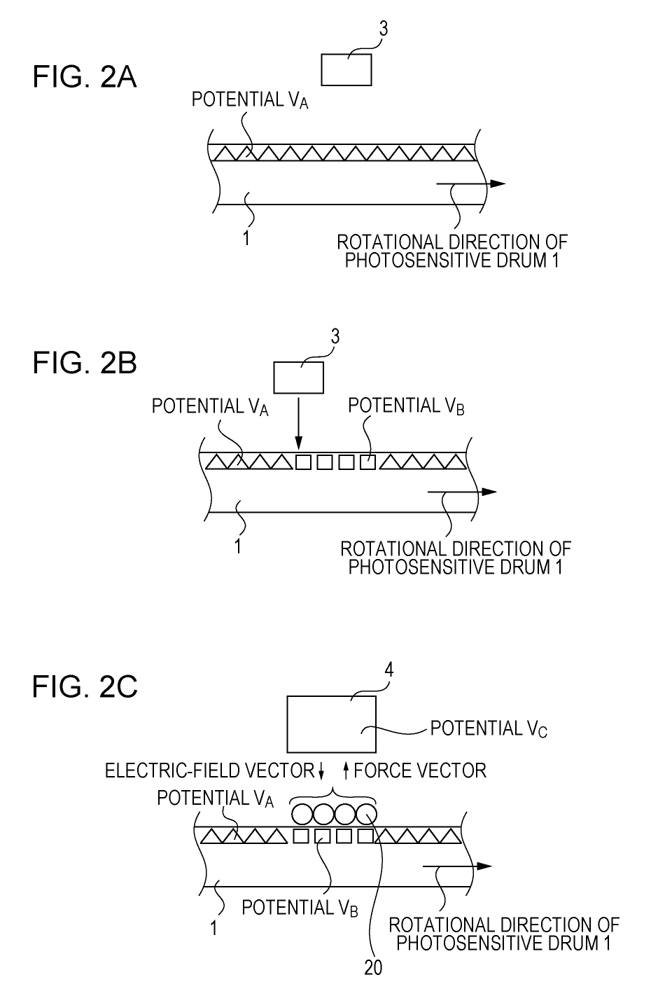

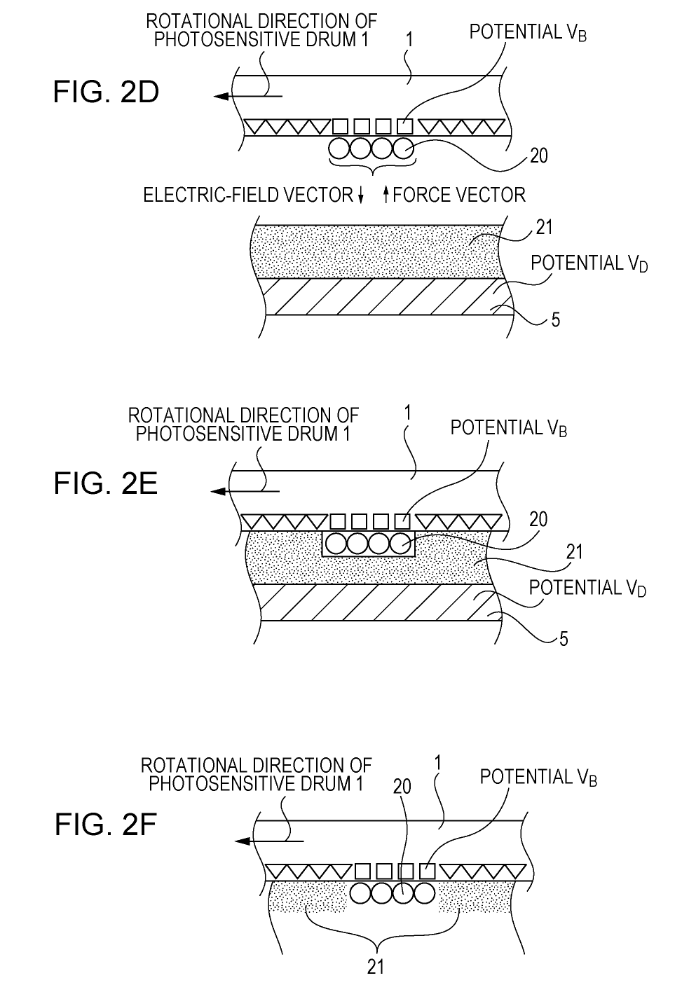

The surface of the photosensitive drum 1 is charged by the charger 2 to −600 V (potential V_{A} in FIG. 2A). Thereafter, an electrostatic latent image is written by the exposure unit 3 at a position corresponding to a non-image portion (potential V_{B}, in FIG. 2B). In the embodiment, the potential V_{B}, is about −30 V.

Next, the developing unit 4 storing the ink repellent particles 20 negatively charged by friction is held at −400 V (potential V_{C}), and the ink repellent particles 20 are adhered to the non-image portion (portion at −30 V) by reversal development (see FIG. 2C). The adhesion of the ink repellent particles 20 is in principle based on the “relationship between an electric-field vector and a force vector”. An electric-field vector in the direction from the exposed surface to the developing unit 4 is formed between the developing unit at −400 V and the exposed surface at −30 V. Thus, at the same time, a force vector in the direction of attracting the ink repellent particles 20 toward the non-image portion (portion at −30 V) acts on the ink repellent particles 20 provided between the developing unit 4 and the non-image portion (portion at −30 V). On the other hand, an electric-field vector in the direction from the developing unit 4 to the unexposed surface at −600 V is formed between the unexposed surface at −600 V and the developing unit 4 at −400V. At the same time, a force vector acts in the direction of moving the ink repellent particles 20 away from the unexposed surface at −600 V. This is the concept commonly used in the developing process of electrophotographic printing.

In the embodiment, the ink repellent particles 20 are adhered by a so-called contact development method. The magnitude of the adhesion for the ink repellent particles 20 may be adjusted under desired conditions by controlling the differences between the potentials V_{A}, V_{B}, and V_{C} with the absolute values of the potentials V_{A}, V_{B}, and V_{C} maintaining the relationship indicated by the formula 1 below in the case where the potentials V_{A}, V_{B}, and V_{C} are each a negative potential.

(Absolute value of potential V_{A})>(Absolute value of potential V_{C})>(Absolute value of potential V_{B}) [Formula 1]

In the case where the oil-based ink 21 is used, resins formed by hydrophilic polymers such as polyvinyl alcohol, polyvinyl pyrrolidone, polyacrylic acid, nylon, and cellulose may be used as the ink repellent particles 20. In addition, hydrophobic and oil-repellent resins formed by fluorine, silicon, or the like may be used as the particles 20. Commercially available particles may also be used as the ink repellent particles 20. Examples of the commercially available particles that may be used as the ink repellent particles 20 include polytetrafluoroethylene powder (Teflon® 7A) manufactured by DU PONT-MITSUI FLUOROCHEMICALS KABUSHIKI KAISHA, a polytetrafluoroethylene resin (PTFE) (Lubron® L-5F) manufactured by DAIKIN INDUSTRIES KABUSHIKI KAISHA, a tetrafluoroethylene/perfluoro (alkyl vinyl ether) copolymer (PFA) (MP10®) manufactured by DU PONT-MITSUI FLUOROCHEMICALS KABUSHIKI KAISHA, and a tetrafluoroethylene hexafluoropropylene copolymer (FEP) (5328000®) manufactured by DU PONT KABUSHIKI KAISHA.

The ink repellent particles 20 may be manufactured as follows.
(1) A desired resin is melted and kneaded, and thereafter transformed into particles by pulverization, dispersion into a liquid, spraying into a gas, or the like.
(2) A desired resin and a corresponding monomer are polymerized with each other and transformed into particles at the same time.

Further, an oil and fat component, a magnetic material, a charge control agent, and so forth may be internally or externally added to the ink repellent particles 20. Other additives that may be mixed with the ink repellent particles 20 include inorganic fine powder, surface-treated inorganic fine powder, and organic fine powder.

In the embodiment, polytetrafluoroethylene powder (Teflon® 7A) manufactured by DU PONT-MITSUI FLUOROCHEMICALS KABUSHIKI KAISHA added with 2 wt % of fine particles of silica is used as the ink repellent particles 20.

In the case of offset printing, when the thickness of the ink 21 to be finally transferred to the paper 11 is 2 μm to 3 μm, an excellent image quality can be obtained. It is necessary that the ink 21 to be supplied to the surface of the photosensitive drum 1 serving as a plate forming member should have a thickness of larger than 2 μm to 3 μm. Thus, the average particle diameter of the ink repellent particles 20 is preferably 5 μm to 170 μm, more preferably 5 μm to 20 μm, and further more preferably 5 μm to 10 μm.

The exposure unit 3 forms an electrostatic latent image on the photosensitive drum 1 by scanning with laser from a semiconductor laser oscillator through rotation of a polygonal mirror. The exposure unit 3 may use a light source formed by arranging LEDs (light emitting diodes).

In the next process, as shown in FIG. 2D, the ink 21 is supplied onto the photosensitive drum 1 by the ink roller 5. In this event, it is desirable that the ink roller 5 and the photosensitive drum 1 should be rotated with the difference in speed between the ink roller 5 and the photosensitive drum 1 in the circumferential direction at the position of contact between the ink roller 5 and the photosensitive drum 1 being substantially zero. The ink roller 5 is formed from a conductive material. The ink roller 5 serving as a recording material supply unit is provided with a voltage application unit serving as an adhesion application unit. A power supply 50 is connected to the ink roller 5 so that a voltage can be applied to the ink roller 5 by controlling the power supply 50. In the embodiment, a voltage of −500 V (potential V_{D}) is applied to the ink roller 5 by controlling the power supply 50. The ink repellent particles 20 are negatively charged, and the non-image portion on the photosensitive drum 1 is charged to −30 V (potential V_{B}). Therefore, an electric-field vector in the direction from the exposed surface to the ink roller 5 is formed between the ink roller 5 at −500 V and the exposed surface at +30 V on the basis of the “relationship between an electric-field vector and a force vector”. Thus, at the same time, a force vector in the direction of adhering the ink repellent particles 20 to the non-image portion (portion at −30 V) acts on the ink repellent particles 20 provided between the ink roller 5 and the non-image portion (portion at −30 V). As a result, the ink repellent particles 20 can be prevented from peeling off from the photosensitive drum 1. In order to generate a force vector in the direction of adhering the ink repellent particles 20 to the non-image portion (portion at −30 V), it is necessary that the absolute values of the potentials V_{B}and V_{D} should satisfy the formula 2 below in the case where the potentials V_{B}and V_{D} are each a negative potential.

(Absolute value of potential V_{D})>(Absolute value of potential V_{B}) [Formula 2]

As shown in FIG. 2E, when the ink roller 5 and the photosensitive drum 1 are further rotated, the ink layer 21 adhering to the circumferential surface of the ink roller 5 is pressed against the photosensitive drum 1 to which the ink repellent particles 20 are adhered.

The ink 21 on the surface of the ink roller 5 pressed against the photosensitive drum 1 does not adhere to the ink repellent particles 20 due to the ink repellency (property to repel ink) of the ink repellent particles 20. Thus, as the ink roller 5 and the photosensitive drum 1 are further rotated to widen the gap in the radial direction, the surface of the ink layer 21 and the ink repellent particles 20 are separated by the ink repellency of the ink repellent particles 20.

In contrast, the portion of the surface of the photosensitive drum 1 which has an affinity for ink (the region to which no ink repellent particles 20 are adhered) is wetted with the ink 21 to adsorb the ink 21. Thus, as the ink roller 5 and the photosensitive drum 1 are further rotated to widen the gap in the radial direction, part of the ink layer 21 adhering to the circumferential surface of the ink roller 5 in the thickness direction is peeled off so that the ink 21 is retained on the surface of the photosensitive drum 1 (see FIG. 2F). This process is the same as in offset printing.

That is, in the embodiment, a surface of the ink repellent particles 20 adhered to the portion of the surface of the photosensitive drum 1 serving as a plate forming member where the latent image is formed by the developing unit 4 serving as a projection forming unit has properties to repel the ink 21 serving as a recording material. Meanwhile, the surface of the photosensitive drum 1 has properties not to repel the ink 21. In the embodiment, in particular, the ink 21 serving as a recording material is oil-based ink, the surface of the ink repellent particles 20 is oil-repellent, and the surface of the photosensitive drum 1 has an affinity for oil.

The thickness of the ink 21 to be retained on the surface of the photosensitive drum 1 is controlled by an adjustment method generally employed in offset printing, such as by adjusting the “amount of the gap between the ink roller 5 and the photosensitive drum 1” or the “thickness of the ink layer 21 on the surface of the ink roller 5”. While the ink repellent particles 20 are illustrated as a single layer in FIGS. 2C to 2F for convenience, the ink repellent particles 20 may be formed in a plurality of layers as long as sufficient adhesion can act on the ink repellent particles 20.

Thereafter, the ink 21 retained on the surface of the photosensitive drum 1 due to its wettability and the ink repellent particles 20 retained on the same surface due to an electromagnetic image force move to the position of contact between the photosensitive drum 1 and the blanket cylinder 8. A rubber material having an affinity for ink is wound around a surface of the blanket cylinder 8 as in a blanket cylinder generally used for offset printing.

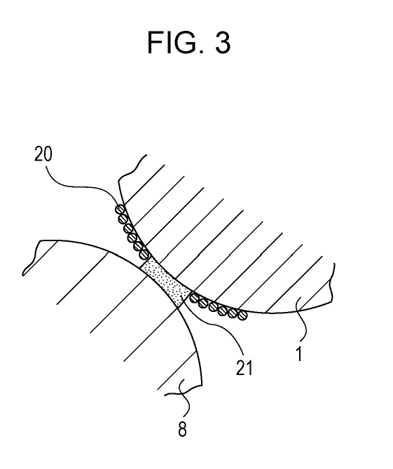

Only part of the ink layer 21 provided on the photosensitive drum 1 in the thickness direction undergoes an intermediate transfer to be transferred to the blanket cylinder 8 which is disposed with a desired gap (see FIG. 3). In this event, the amount (thickness) of the ink layer 21 to be transferred is controlled by an adjustment method generally employed in offset printing, such as by adjusting the “amount of the gap between the photosensitive drum 1 and the blanket cylinder 8”. It is a matter of course that the amount of the ink layer 21 to be transferred is also relevant to adjusting the thickness of the ink 21 to be retained on the surface of the photosensitive drum 1, and that it may be necessary to adjust the “amount of the gap between the ink roller 5 and the photosensitive drum 1”, the “thickness of the ink layer 21 on the surface of the ink roller 5”, or the like.

Thereafter, the region on the photosensitive drum 1 which has undergone the intermediate transfer process moves to the position of the first cleaner 1 shown in FIG. 1. The first cleaner 7 performs cleaning after collectively scraping off the ink repellent particles 20 and the ink 21 using a rubber blade. A drying unit may be provided after the cleaning process performed by the first cleaner 7 as necessary.

Thereafter, the region on the photosensitive drum 1 moves to the position of the charge eliminating unit 6, which eliminates charges from the region.

In a final process, an image formed by the ink 21 transferred to the blanket cylinder 8 through the intermediate transfer is transferred to the paper 11 serving as a recording medium interposed between the blanket cylinder 8 and the impression cylinder 9 to complete printing.

The second cleaner 9 removes the remaining ink from the region on the blanket cylinder 8 which has undergone the transfer to the paper 11 serving as a recording medium to restore the region to its initial state.

Thereafter, the operation of the charger 2, the operation of the exposure unit 3, and so forth are performed again to achieve on-demand digital offset printing.

While printing is performed using ink in a single color, for example black, for convenience in the above description, the configuration of FIG. 1 may be provided for each of inks 21 in cyan, magenta, and yellow colors to perform full-color printing.

To sum up, the printing method according to the embodiment uses a rewritable plate. The method includes a first step of writing a latent image onto a surface of the photosensitive drum 1 serving as a plate forming member that forms a rewritable plate, and a second step of adhering the ink repellent particles 20 to a surface of the photosensitive drum 1 on the basis of the latent image to form a projection. The method further includes a third step of supplying the ink 21 serving as a recording material to the surface of the photosensitive drum 1 to form an image portion, and a fourth step of transferring the ink 21 on the surface of the photosensitive drum 1 to the blanket cylinder 8 serving as an intermediate transfer member. The method includes a step of providing the ink repellent particles 20 with adhesion to the photosensitive drum 1 serving as a plate forming member during the third step. The method further includes a fifth step of transferring the ink 21 on a surface of the blanket cylinder 8 to the paper 11 serving as a recording medium.

A surface of the ink repellent particles 20 has properties to repel the ink 21, and the surface of the photosensitive drum 1 has properties not to repel the ink 21.

When printed materials of the same content are to be output, the operations of the first cleaner 7, the charge eliminating unit 6, the charger 2, the exposure unit 3, and the developing unit 4 may be skipped after development is performed once using the ink repellent particles 20 to enable high-speed printing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-280995 filed Dec. 10, 2009, which is hereby incorporated by reference herein in its entirety.

What is claimed is:

1. A printing apparatus comprising:
a plate forming member that forms a rewritable plate;
a latent image forming unit configured to write a latent image onto a surface of the plate forming member;
a projection forming unit configured to selectively adhere ink repellent particles to a portion of the surface of the plate forming member where the latent image is formed in order to form a projection;
a recording material supply unit configured to supply a recording material to the surface of the plate forming member;
an intermediate transfer member for transfer of the recording material supplied to the surface of the plate forming member;
a pressing unit configured to press the recording material on a surface of the intermediate transfer member during transfer of the recording material to a recording medium; and
a conveying unit configured to convey the recording medium,
a surface of the ink repellent particles having properties to repel the recording material, and the surface of the plate forming member having properties not to repel the recording material,
wherein the printing apparatus further comprises a unit configured to apply a voltage to the recording material supply unit in order to provide the ink repellent particles with adhesion to the plate forming member.

2. The printing apparatus according to claim 1,
wherein the recording material is oil-based ink, the surface of the ink repellent particles is oil-repellent, and the surface of the plate forming member has an affinity to oil.

3. A printing method comprising:
a first step of writing a latent image onto a surface of a plate forming member that forms a rewritable plate;
a second step of adhering ink repellent particles to the surface of the plate forming member on the basis of the latent image to form a projection;
a third step of supplying a recording material to the surface of the plate forming member to form an image portion;
a fourth step of transferring the recording material on the surface of the plate forming member to an intermediate transfer member; and
a fifth step of transferring the recording material on a surface of the intermediate transfer member to a recording medium,
a surface of the ink repellent particles having properties to repel the recording material, and the surface of the plate forming member having properties not to repel the recording material,
wherein the printing method further comprises a step of applying a voltage to a unit configured to supply the recording material in order to provide the ink repellent particles with adhesion to the plate forming member during the third step.

4. The printing method according to claim 3,
wherein the recording material is oil-based ink, the surface of the ink repellent particles is oil-repellent, and the surface of the plate forming member has an affinity to oil.
